(19) United States
(12) Patent Application Publication
(10) Pub. No.: US 2023/0030521 A1
(43) Pub. Date: Feb. 2, 2023

(54) MAGNESIUM REMOVAL AGENT AND PRODUCTION METHOD FOR ALUMINUM ALLOY

(71) Applicants: KABUSHIKI KAISHA TOYOTA CHUO KENKYUSHO, Nagakute-shi (JP); TOYOTA TSUSHO CORPORATION, Nagoya-shi (JP); TOYOTA JIDOSHA KABUSHIKI KAISHA, Toyota-shi (JP)

(72) Inventors: Kazuma HIBI, Nagakute-shi (JP); Jun YAOKAWA, Nagakute-shi (JP); Hiroyuki MORI, Nagakute-shi (JP); Takuma MINOURA, Nagakute-shi (JP); Hiroshi KAWAHARA, Nagakute-shi (JP); Yasushi IWATA, Nagakute-shi (JP); Kyosuke ITO, Nagoya-shi (JP); Satoshi NAKANO, Tahara-city (JP); Hiroyuki ISHII, Miyoshi-shi (JP); Akira KANO, Toyota-shi (JP); Yusei KUSAKA, Toyota-shi (JP)

(73) Assignees: KABUSHIKI KAISHA TOYOTA CHUO KENKYUSHO, Nagakute-shi (JP); TOYOTA TSUSHO CORPORATION, Nagoya-shi (JP); TOYOTA JIDOSHA KABUSHIKI KAISHA, Toyota-shi (JP)

(21) Appl. No.: 17/862,598

(22) Filed: Jul. 12, 2022

(30) Foreign Application Priority Data
Jul. 13, 2021 (JP) 2021-115954

(51) Int. Cl. C22B 21/06; C22B 21/00

(52) U.S. Cl. CPC C22B 21/062; C22B 21/0092

(57) ABSTRACT

A Mg removal agent is composed of a chloride and copper oxide. The chloride contains at least Mg and one or more base metal elements selected from K, Na, and Ca. The chloride contains, for example, 0.2 to 60 mass % of MgCl₂ and/or 40 to 99.8 mass % of KCl with respect to the chloride as a whole. The compounding ratio that is a mass ratio of the chloride to the copper oxide is, for example, 0.15 or more. The chloride may be a re-solidified salt or a mixed salt. At least a part of the chloride may be a mineral containing the base metal elements and Mg or a mineral-derived chloride. A preferred example of the Mg removal agent is granular flux introduced into the aluminum alloy molten metal.

### TECHNICAL FIELD

The present invention relates to flux or the like that removes Mg (magnesium) from an aluminum alloy molten metal and relates also to relevant techniques.

### BACKGROUND ART

With the heightened environmental awareness, lightweight aluminum-based members are being used in various fields. Rather than using newly refined aluminum, the reuse of scrap allows for promotion of the use of aluminum-based members while saving energy, reducing the environmental load, achieving a carbon-neutral society, etc.

When scrap is used, however, various elements other than Al may be mixed in the molten metal. Unnecessary or excess elements have to be removed from the raw material molten metal obtained by melting scrap (also referred to as a “molten Al alloy”). As an example, there are descriptions related to the removal of Mg in the following documents.

### PRIOR ART DOCUMENTS

### Patent Documents

[Patent Document 1] U.S. Pat. No. 4,097,270A
[Patent Document 2] JP2007-154268A
[Patent Document 3] JP2008-50637A
[Patent Document 4] JP2011-168830A
[Patent Document 5] GB451271A
[Patent Document 6] SU1008261A

### Non-Patent Documents

[Non-Patent Document 1] Journal of Japan Institute of Light Metals, vol. 33 (1983), pp. 243-248
[Non-Patent Document 2] Journal of Japan Institute of Light Metals, vol. 54 (2004), pp. 75-81

### SUMMARY OF INVENTION

### Technical Problem

Patent Document 1 describes a method (a type of metal oxide processing method) in which a molten Al alloy containing Mg is reacted with silica (SiO₂) (2Mg+SiO₂→2MgO+Si) to remove Mg as MgO.

Patent Document 2 proposes a method in which pellets containing aluminum borate (9Al₂O₃.2B₂O₃) are added to a molten Al alloy containing Mg to cause Mg to adhere onto the pellets and Mg is removed as a reaction product (MgAl₂O₄).

Patent Documents 3 and 4 propose a method in which powdered battery residues obtained by roasting used dry batteries are added to a molten Al alloy containing Mg to remove Mg. The main components of battery residues are ZnO and MnO₂, and Mg is removed as a reaction product with these oxides (MgO, MgMn₂O₄, or MgMnO₃). The chloride contained in the battery residues enhances the wettability of these oxides with the molten Al alloy to promote the generation of the reaction product. In the case of alkaline dry batteries whose battery residues have a smaller chloride amount than that in the battery residues of manganese dry batteries, some chloride (mixed salt of KCl and NaCl) is supplementarily added.

In Patent Document 5, a mixed salt of magnesium chloride and zinc chloride is used as a purification flux for a molten Al alloy. Expensive copper chloride is also exemplified as a salt that can be used for the flux, but a specific example thereof is not described in Patent Document 5.

Patent Document 6 proposes to purify a molten Al alloy by further adding copper oxide powder to flux (mixed salt consisting only of NaCl and KCl) dissolved on a molten Al alloy containing Mg. Specifically, 3 to 5 g of copper oxide is added to 100 g or 150 g of the mixed salt (mass ratio of the mixed salt to the copper oxide: 20 to 50). It is considered that the copper oxide was less likely to decompose in the mixed salt of NaCl and KCl, and only a small amount of copper oxide was able to be added to the mixed salt.

Non-Patent Documents 1 and 2 describe a chlorine gas processing method and a flux processing method. In the chlorine gas processing method, Mg reacted with a gas such as chlorine, hexachlorethane, or carbon tetrachloride blown into a molten Al alloy is removed as MgCl₂ (Mg+Cl₂→MgCl₂). In the flux processing method, Mg reacted with fluoride (such as AlF₃, NaAlF₄, or K₃AlF₆) added to a molten Al alloy is removed as MgF₂ (e.g., 3Mg+2AlF₃→3MgF₂+2Al). Such a processing method increases the amount of Al that is trapped in dross or the like and causes loss, and leads to deterioration in the working environment, generation of hazardous waste, etc.

The present invention has been made in view of such circumstances and an object of the present invention is to provide a novel Mg removal agent or the like that can efficiently remove Mg from a molten Al alloy and relevant techniques.

### Solution to Problem

As a result of intensive studies to achieve the above object, the present inventors have newly found that the concentration of Mg contained in a molten Al alloy can be efficiently reduced by using flux having a copper oxide and a chloride that contains Mg as a target of removal. Developing this achievement, the present inventors have accomplished the present invention, which will be described hereinafter.

### «Metal Removal Agent»

The present invention provides a Mg removal agent used for removing Mg from an aluminum alloy molten metal. The metal removal agent contains a chloride and a copper oxide. The chloride has at least Mg and one or more base metal elements selected from K, Na, and Ca.

According to the Mg removal agent of the present invention (also simply referred to as a “removal agent”), Mg can be removed from the aluminum alloy molten metal (referred to as a “molten Al alloy” or simply referred to as a “molten metal,” as appropriate) with high efficiency or low cost while avoiding the generation of hazardous waste, deterioration in the working environment, etc.

### «Production Method for Aluminum Alloy, Etc.»

The present invention is also perceived as a production method for obtaining an aluminum alloy having a reduced Mg concentration (purification method for an aluminum alloy molten metal, Mg removal method, or the like). The production method includes bringing the above-described Mg removal agent into contact with an aluminum alloy molten metal containing Mg. The method of bringing the removal agent into contact with the molten metal is performed, for example, by addition of the removal agent to the molten metal surface, forced introduction of the removal agent into the molten metal (such as pressure feeding by a feeder), or the like.

When the molten metal before removal of Mg (also referred to as a “raw material molten metal,” as appropriate) is prepared by using aluminum-based scrap, the present invention may also be perceived as a production method for a recycled aluminum alloy (such as a method of recycling an aluminum alloy). The Al alloy after removal of Mg may be used as a solidified material (such as an ingot) or may also be used as a molten metal (including a semi-molten state) without any modification.

### «Others»

(1) Unless otherwise stated, the concentration and composition as referred to in the present specification are indicated by the mass ratio (mass %) of an object (such as a molten metal or a composition) to the whole. The mass % is simply indicated by “%” as appropriate.

(2) The specific composition of the molten metal before removal of Mg is not limited, provided that the molten metal contains Mg and Al is the main component (content of Al is more than 50 atomic % in an embodiment, 70 atomic % or more in another embodiment, or 85 atomic % or more in still another embodiment with respect to the molten metal as a whole). The Mg concentration before removal of Mg with respect to the molten metal as a whole is not limited, but may be, for example, 3 mass % or less in an embodiment or 1 mass % or less in another embodiment. The molten metal or alloy after removal of Mg may be used for casting or as a wrought material.

(3) Unless otherwise stated, a numerical range “x to y” as referred to in the present specification includes the lower limit x and the upper limit y. Any numerical value included in various numerical values or numerical ranges described in the present specification may be selected or extracted as a new lower or upper limit, and any numerical range such as “a to b” can thereby be newly provided using such a new lower or upper limit.

### BRIEF DESCRIPTION OF DRAWINGS

FIG. 1 is a standard formation free energy diagram of metal oxides and metal chlorides at 660° C.

FIG. 2 is an explanatory diagram illustrating a mechanism with which Mg is removed from a molten Al alloy by flux.

FIG. 3A is a schematic process flow diagram illustrating a Mg removal process using flux composed of a re-solidified salt and a copper oxide.

FIG. 3B is a graph illustrating the relationship between the compounding ratio of flux and the Mg concentration in a molten Al alloy and its enlarged partial section (compounding ratio: 0 to 1.05).

FIG. 3C is a set of photographs showing the molten metal surface and slagged ash after the Mg removal process.

FIG. 4 is a graph illustrating the relationship between the MgCl₂ concentration in a chloride and the Mg concentration in a molten Al alloy.

FIG. 5 is a graph illustrating the relationship between the retention time of the Mg removal process and the Mg concentration or Cu concentration in a molten Al alloy.

FIG. 6A is a schematic process flow diagram illustrating a Mg removal process using flux composed of a mixed salt and a copper oxide.

FIG. 6B is a bar graph illustrating the Mg concentration and Cu concentration in a molten Al alloy by the Mg removal process.

FIG. 7A is a schematic process flow diagram illustrating a Mg removal process using flux containing carnallite.

FIG. 7B is a bar graph illustrating the Mg concentration in a molten Al alloy by the Mg removal process.

### EMBODIMENTS FOR CARRYING OUT THE INVENTION

One or more features freely selected from the present specification can be added to the above-described features of the present invention. The content described in the present specification can be features regarding a product (e.g., removal agent or Al alloy (molten metal)) even if the content represents methodological features.

### «Principle of Mg Removal»

The principle with which Mg is removed from a molten Al alloy by the removal method of the present invention is considered as follows.

(1) Redox reaction (electrochemical reaction)

Mg contained in the molten Al alloy can be oxidized as follows.

Anode reaction: Mg→Mg²⁺+2e⁻ (10a)

On the other hand, Cu²⁺ contained in the removal agent can be reduced as follows and precipitated.

Cathode reaction: Cu²⁺+2e⁻→Cu (10b)

### (2) Copper Oxide

When the source of Cu²⁺ is CuO, the above-described redox reaction is represented as follows.

CuO+Mg→Cu+MgO (1)

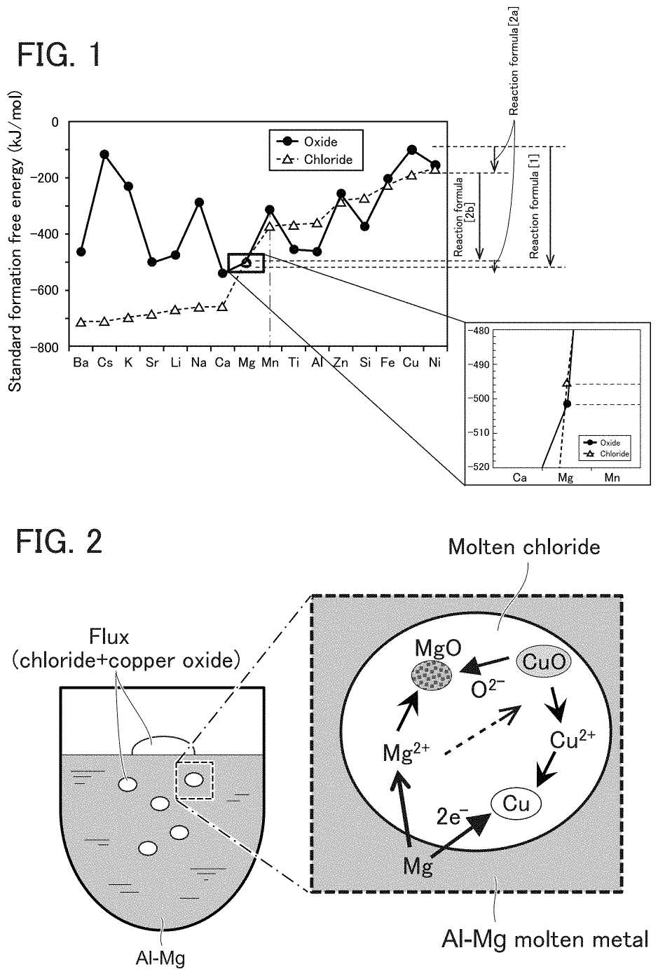

On the basis of the standard formation free energy (also simply referred to as “free energy”) of chlorides/oxides of metal elements illustrated in FIG. 1, the reaction formula (1) proceeds in a stable direction in which a free energy change ΔG is negative (ΔG<0), that is, from the left side to the right side.

Note that each free energy illustrated in FIG. 1 relies on Knacke O., Kubaschwski O., Hesselmann K., “Thermochemical Properties of Inorganic Substances” (1991), SPRINGER-VERLAG FIG. 1 illustrates each free energy at 660° C. The tendency (magnitude relationship) of each free energy at least at 660° C. to 800° C. is the same as that of each free energy illustrated in FIG. 1.

According to the experiment of the present inventors, even when CuO was added to the molten Al alloy without any modification, the reaction formula (1) did not easily proceed because CuO is less likely to get wet with the molten Al alloy. Moreover, even when CuO was added to the molten Al alloy together with a mixed salt consisting only of NaCl and KCl, the progress of the reaction formula (1) was still slow.

On the other hand, when copper chloride (CuCl₂) was used as the Cu²⁺ source, the redox reaction represented below proceeded easily. Note, however, that CuCl₂ is not preferred as a raw material of a removal agent (such as flux) used for industrial purification of Al alloys because CuCl₂ itself is expensive.

CuCl₂+Mg→Cu+MgCl₂ (2b)

### (3) Magnesium Chloride (MgCl₂)

As a result of further research by the present inventors, it has been found that when a removal agent that contains CuO and a chloride (e.g., MgCl₂) containing Mg as a target of removal from a molten Al alloy is used, the following reaction proceeds easily.

CuO+MgCl₂→CuCl₂+MgO (2a)

CuCl₂ obtained by the reaction formula (2a) contributes to the trap of Mg from the molten Al alloy according to the above-described reaction formula (2b). The fact that both the reaction formula (2a) and the reaction formula (2b) proceed from the left side to the right side also coincides with the reaction direction being a stable direction in which each free energy change ΔG illustrated in FIG. 1 is negative (ΔG<0).

The Mg trapped from the molten Al alloy to the removal agent changes as MgCl₂→MgO and does not return from MgO to MgCl₂. This can be seen from the fact that the free energy of Mg oxide (MgO) is smaller than that of Mg chloride (MgCl₂) as illustrated in the enlarged part of FIG. 1. Thus, the Mg in the molten Al alloy is incorporated into the removal agent as MgO and decreases.

### (4) Summary of Above

When the reaction formula (2a) and the reaction formula (2b) are combined, the reaction formula (1) is obtained. In other words, the reaction formula (1) can be divided into the reaction formula (2a) and the reaction formula (2b) (see FIG. 1). In this case, it is considered that MgCl₂ appearing in the reaction formulae (2a) and (2b) acts catalytically to progress the reaction formula (1) from the left side to the right side.

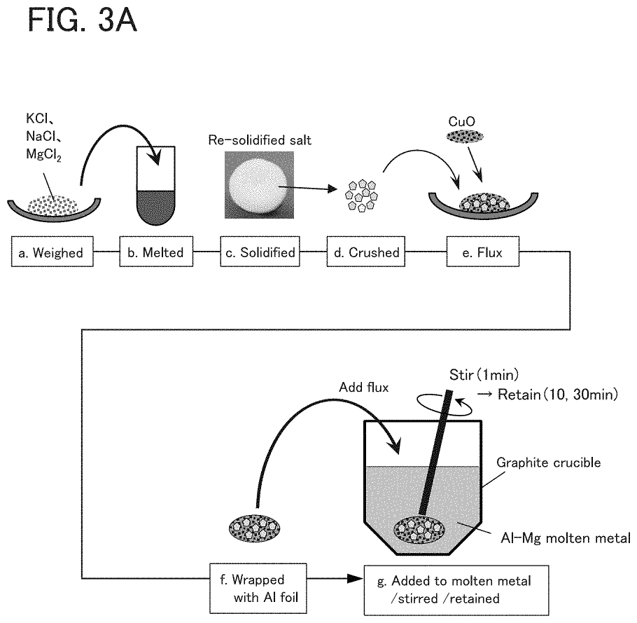

Thus, when the removal agent composed of a copper oxide and a chloride containing Mg is brought into contact with the molten Al alloy, the reaction formula (1) proceeds and Mg in the molten Al alloy is removed as MgO. The CuO in the removal agent can precipitate as reduced Cu. Each of such reactions is schematically illustrated in FIG. 2.

Although the reason is not clear, most of the precipitated Cu is incorporated into the removal agent (molten chloride) and basically does not mix into the molten Al alloy. Moreover, CuO is relatively inexpensive and therefore suitable as a raw material of a removal agent (such as flux) used for industrial purification of Al alloys.

### «Chloride»

The chloride may contain at least a base metal element and Mg. The chloride may be a metal chloride consisting only of a metal element and Cl, but may also contain other non-metal elements (including halogen elements). Additionally or alternatively, the chloride may contain Mg and a metal element other than a specific base metal element (e.g., an alkali metal (such as Li) or an alkaline earth metal (such as Ba) other than K, Na, or Ca).

The base metal element consists of one or more selected from K, Na, and Ca. Chloride of a base metal element (simply referred to as a “base salt”) is stable (see FIG. 1) and does not directly participate in the above-described redox reaction or the like. The base salt contributes to ensuring wettability with the molten Al alloy, collection characteristics of Mg from the molten Al alloy, retention characteristics of products (e.g., MgO and precipitated Cu), etc.

The base salt may be a single salt of KCl, NaCl, or CaCl₂ or may also be a composite salt thereof. The use of a composite salt allows for adjustment of the melting point, vapor pressure, density, wettability, hygroscopic property, etc. and cost reduction. The composite salt may contain KCl, which is stable and has a relatively low melting point (see FIG. 1). The content of KCl may be, for example, 40 to 99.8 mass % in an embodiment, 50 to 80 mass % in another embodiment, or 55 to 60 mass % in still another embodiment with respect to the chloride as a whole. Additionally or alternatively, the content of NaCl may be, for example, 25 to 65 mass % in an embodiment, 30 to 50 mass % in another embodiment, or 35 to 45 mass % in still another embodiment with respect to the chloride as a whole.

The chloride (all or part) containing a base metal element and Mg may be any of a mixture of two or more raw material salts (mixed salt), a re-solidified salt obtained by melting one or more raw material salts as a whole and then solidifying the one or more raw material salts, a mineral or a mineral-derived chloride obtained from mineral, etc. Examples of the mineral containing a base metal element and Mg include carnallite. Examples of the mineral-derived chloride include an anhydride of the carnallite (e.g., KMgCl₃).

As described above, the Mg contained in the chloride (further, MgCl₂) acts catalytically in the Mg removal process (particularly in its initial stage) from the molten Al alloy. The content of Mg in the chloride is therefore sufficient if it can progress the reaction formula (2a) to the right side. To this end, the removal agent may contain MgCl₂, for example, of 0.2 to 60 mass % in an embodiment, 0.3 to 55 mass % in another embodiment, 0.4 to 40 mass % in still another embodiment, 0.5 to 30 mass % in yet another embodiment, 2 to 20 mass % in a further embodiment, or 7 to 15 mass % in a still further embodiment with respect to the chloride as a whole. If the content of MgCl₂ is unduly large, vaporization of MgCl₂ and generation of chlorine gas (Cl₂) are likely to occur during the Mg removal process.

During the Mg removal process, MgCl₂ becomes MgO and is consumed as represented by the reaction formula (2a). On the other hand, the Mg taken in from the molten Al alloy becomes MgCl₂ as represented by the reaction formula (2b). While repeating such consumption and supplement of MgCl₂, the Mg in the molten Al alloy is removed as MgO in accordance with the amount of CuO contained in the removal agent.

### «Copper Oxide»

The copper oxide is mainly CuO, but may contain Cu₂O. At least a part of CuO may be changed to Cu₂O during the Mg removal process.

### «Compounding Ratio»

Both the chloride and the copper oxide are required to efficiently remove Mg from the molten Al alloy. The compounding ratio (chloride/copper oxide), which is the mass ratio of the chloride to the copper oxide, may be, for example, 0.15 or more. Furthermore, the compounding ratio may also be, for example, 0.2 to 9 in an embodiment, 0.25 to 7 in another embodiment, 0.5 to 5 in still another embodiment, or 0.7 to 2.5 in yet another embodiment.

### «Mg Removal Agent»

The removal agent may be a mixture of the chloride and the copper oxide or a re-solidified product thereof. The removal agent can take various forms such as a massive form and a granular form (crushed powder, granular powder, powder, etc.). When the removal agent is in a granular form, its grain size (also referred to as a “particle diameter”) is, for example, such that the maximum length (diameter) is about 0.1 to 8 mm in an embodiment, about 0.5 to 5 mm in another embodiment, or about 1 to 3 mm in still another embodiment. The particle diameter and particle size distribution of the removal agent are adjusted in consideration of the dispersibility, solubility, etc. in the molten Al alloy.

The Mg removal agent is, for example, a granular flux or its raw material mass (solid substance) introduced into the molten Al alloy. Additionally or alternatively, the Mg removal agent may be used to form a molten salt layer having a predetermined thickness on the surface of the molten Al alloy.

### EXAMPLES

Various types of flux were introduced into molten Al alloys containing Mg, and the Mg removal amount (degree of decrease in the Mg concentration) by each type of flux was evaluated. The present invention will be described in more detail based on such specific examples.

### «Outline of Mg Removal Process»

### (1) Molten Al Alloy

Any of molten metals 1 to 4 listed in Table 1 was used as a molten Al alloy containing Mg as a target of removal (also referred to as an “Al—Mg molten metal”/raw material molten metal). Each molten metal was prepared by melting in a graphite crucible an alloy raw material weighed in accordance with a desired composition. Unless otherwise stated, the amount of molten metal used in the experiment was set to 710° C. (±20° C.) and 1000 g.

### (2) Chloride

Unless otherwise stated, any set of chlorides 1 to 5 listed in Table 2 was used as the chlorides constituting flux. As the base salts thereof, composite salts of NaCl and KCl were used. Unless otherwise stated, each set of chlorides was a mixed salt or a re-solidified salt.

The mixed salt was prepared by mixing the powdered raw material salts (NaCl, KCl, and MgCl₂) weighed to a desired composition without any modification. Commercially available reagents were used as the raw material salts. The same applies to the copper oxide, which will be described later.

The re-solidified salt was prepared as follows. First, the raw material salts (NaCl and KCl) to be the base salt were placed in an alumina Tammann tube and heated to 730° C. (±20° C.) to melt them. MgCl₂ was added to the molten base salt, and the molten salt obtained by melting the whole was poured into a mold (φ40×20) and solidified. The obtained solid salt was crushed in an alumina mortar to form granules having a particle diameter (maximum length) of 5 mm or less. The above processes were performed in the air atmosphere.

### (3) Flux

Each chloride and powdered copper oxide (CuO) were weighed to prepare flux having a compounding ratio listed in Table 3. The compounding ratio is the mass ratio of the chloride to the copper oxide. Table 3 also lists the mass ratio of the chloride to the flux as a whole (chloride+copper oxide). Unless otherwise stated, the compounding ratio of flux was any of those listed in Table 3.

### (4) Mg Removal Process

Granular flux (including powdered flux) (chloride and copper oxide) was wrapped with commercially available aluminum foil (thickness: 11 μm) and introduced into the molten Al alloy in a crucible. The molten metal into which the flux was introduced was stirred with a protective tube of alumina for 1 minute and then retained (statically placed) for 10 minutes or 30 minutes. The molten metal during the process was retained at a constant temperature by an electric furnace.

### (5) Analysis

The molten Al alloy was sampled from the vicinity of the center of the crucible after a predetermined retention time passed, and was poured into a mold (stainless analytical mold) and naturally solidified in the atmosphere to obtain an analysis sample (Al alloy).

The chemical components (Mg concentration, Cu concentration) of the Al alloy were analyzed by an X-ray fluorescence analyzer (XRF: ZSX Primus II available from Rigaku Corporation). Each component composition (concentration) indicated in the present examples is a mass ratio to the Al alloy as a whole.

### «Example 1»

The effect of the flux compounding ratio on the Mg concentration of a molten Al alloy was evaluated by the following experiments.

### (1) Processing

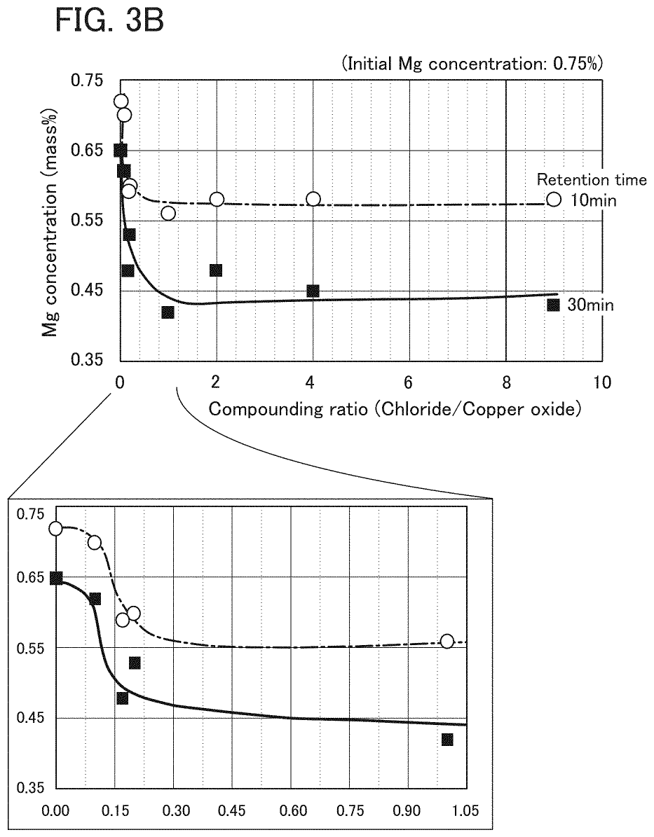

Each flux having a different compounding ratio (Table 3) was added to the molten Al alloy (molten metal 1 of Table 1), and the Mg removal process was performed in accordance with the procedure illustrated in FIG. 3A. Compounding of the flux was performed by adjusting the mass of the re-solidified chloride 4 (Table 2) with respect to CuO: 5 g (constant). For example, in the case of flux having a compounding ratio: 1, the chloride 4 (KCl-41.8% NaCl-5% MgCl₂): 5 g was compounded to CuO: 5 g.

### (2) Evaluation

The relationships between the compounding ratio of flux and the Mg concentration in the molten Al alloy after the processing is collectively illustrated in FIG. 3B.

As is apparent from FIG. 3B, it has been found that the coexistence of the copper oxide and the chloride containing Mg allows the amount of Mg to be efficiently reduced in the molten Al alloy even when the retention time is about 10 minutes. In particular, it has been found that the Mg concentration is sharply lowered when the compounding ratio is 0.15 or more. It has also been found that when the compounding ratio is 0.5 or more in an example or 1 or more in another example, the Mg concentration becomes almost the minimum value, and even when the compounding ratio increases more than that, the state is maintained (i.e., the saturated state is reached).

When the above-described compounding ratio of flux was adjusted to 9, the chloride came to form a molten salt layer on the surface of the molten metal (molten metal surface). Considering the Mg removal processability (workability) by flux, the compounding ratio may be adjusted to 9 or less in an embodiment or 8 or less in another embodiment.

### (3) Observation

The molten metal surface and slagged ash after the process were observed. FIG. 3C collectively shows the observation examples (retention time: 30 minutes) when the compounding ratio of flux was set to 0 or 1. When the compounding ratio was 0, unreacted CuO was observed on the molten metal surface and on the ash. On the other hand, when the compounding ratio was 1, no such CuO was observed on the molten metal surface or on the ash. It is considered that the molten chloride (in particular, the base salt) improves the wettability of copper oxide with the molten Al alloy and Mg is efficiently removed from the molten Al alloy.

Moreover, as can be seen from FIG. 3C, when the compounding ratio was 0, trapped metal Al was observed on the molten metal surface and slagged ash. On the other hand, when the compounding ratio was 1, the molten metal surface or the slagged ash contained no such metal Al and was in a dry state.

### «Example 2»

The effect of the MgCl₂ concentration in the flux (chloride) on the Mg concentration of the molten Al alloy was evaluated by the following experiments.

### (1) Processing

Flux consisting of the copper oxide and each of the chlorides 1 to 5 (Table 2) having different MgCl₂ concentrations was added to the molten metal 1 (Table 1), and the Mg removal process was performed in the same manner as in Example 1 in accordance with the procedure illustrated in FIG. 3A. In this example, the compounding ratio was set to 1 (CuO: 5 g, each chloride: 5 g).

### (2) Evaluation

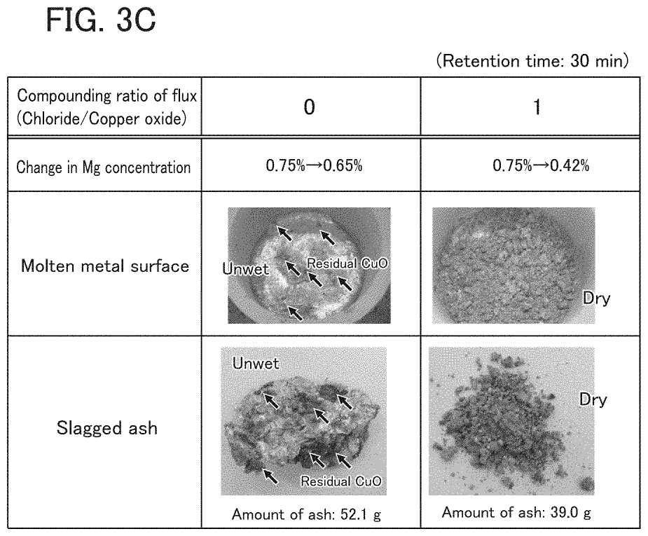

The relationship between the MgCl₂ concentration in the chloride and the Mg concentration in the Al alloy after the processing is collectively illustrated in FIG. 4.

As is apparent from FIG. 4, it has been found that by containing Mg (Mg²⁺) in the chloride, Mg can be efficiently removed from the molten Al alloy even when the retention time is about 10 minutes. In particular, it has become clear that even when the MgCl₂ concentration in the chloride is slightly over only 0.3 mass % (e.g., 0.5 to 7 mass % in an example or 1 to 6 mass % in another example), the Mg concentration is sharply lowered. It is considered that the previously described reaction formula (1) proceeds via the reaction formulae (2a) and (2b).

### «Example 3»

The effect of the retention time after the introduction of flux on the Mg concentration of the molten Al alloy was evaluated by the following experiments.

### (1) Processing

Flux consisting of the chloride 4 (Table 2): 10 g and the copper oxide: 10 g (compounding ratio: 1) was added to the molten metal 2 (Table 1): 1800 g, and the Mg removal process was performed in the same manner as in Example 1 in accordance with the procedure illustrated in FIG. 3A. In this example, however, the retention time for the flux introduced into the molten Al alloy after the stirring was set to 10 minutes, 20 minutes, 30 minutes, or 60 minutes.

### (2) Evaluation

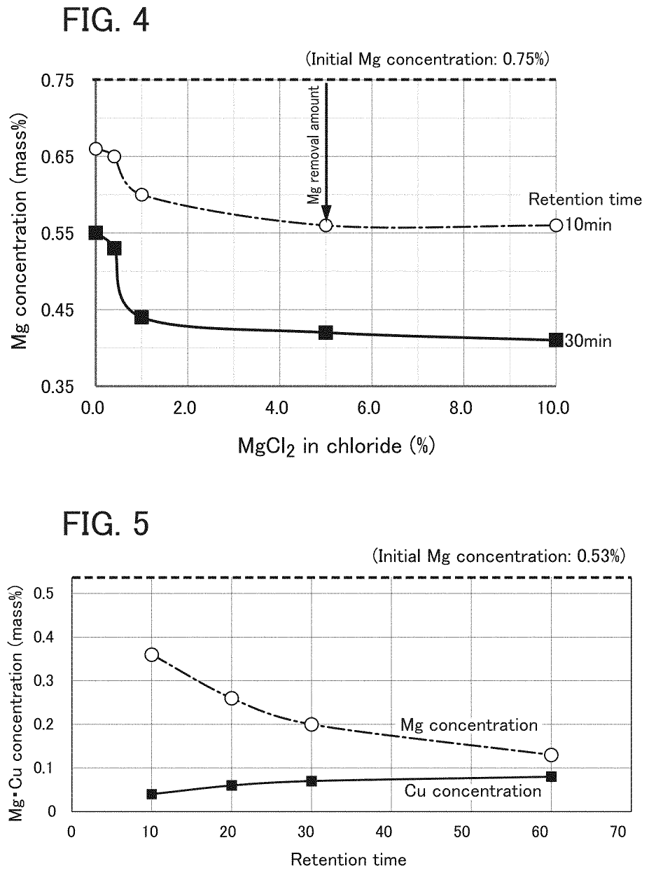

The relationship between the retention time and the Mg concentration in the Al alloy after the processing is collectively illustrated in FIG. 5. As is apparent from FIG. 5, it has been found that the Mg concentration in the molten Al alloy decreases with the retention time, but it has also been found that the Mg concentration in the molten Al alloy is sufficiently lowered in a retention time of about 20 minutes.

### «Example 4»

The effect of flux prepared using a chloride with a changed preparation method and a changed MgCl₂ concentration on the Mg concentration decrease in the molten Al alloy was evaluated by the following experiments.

### (1) Flux

A mixed salt (KCl-10% NaCl-50% MgCl₂) obtained by merely mixing powdered raw material salts (KCl: 1 g, NaCl: 0.5 g, MgCl₂: 1.5 g) without re-solidification was prepared as the chloride. Copper oxide: 6 g was added to the mixed salt: 3 g (compounding ratio: 0.5) to obtain powdered flux.

### (2) Processing

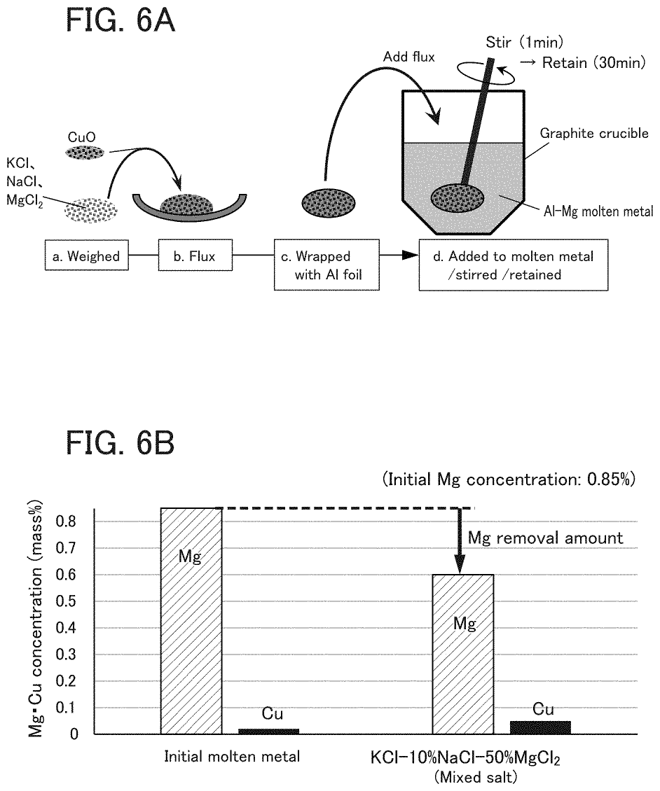

The Mg removal process was performed by adding the flux to the molten Al alloy (molten metal 3 of Table 1/1000 g) in accordance with the procedure illustrated in FIG. 6A. The temperature of the molten metal was set to 750° C. and the retention time after the stirring was set to 30 minutes.

### (3) Evaluation

The Mg concentration and Cu concentration in the Al alloy before and after the Mg removal process are illustrated in FIG. 6B in comparison. As is apparent from FIG. 6B, it has been found that the Mg concentration in the molten Al alloy can be sufficiently lowered even with the flux prepared using a mixed salt having a high MgCl₂ concentration.

The Cu concentration in the molten Al alloy remained almost unchanged before and after the Mg removal process. From this, it has also been found that the Cu precipitated by the Mg removal process was less likely to be mixed in the molten Al alloy and was incorporated into the flux residue (slagged ash).

### «Example 5»

The effect of flux prepared using a mineral-derived chloride on the Mg concentration decrease in the molten Al alloy was evaluated by the following experiments.

### (1) Flux

The chloride was prepared by using a melt-dehydrated carnallite (Promag F available from Pyrotek Japan Co., Ltd.). Its composition (mass ratio) was KCl-45.5% MgCl₂. The composition analysis was conducted for K with an atomic absorption method, for Mg with an ICP emission spectroscopic analysis method, and for Cl with an ion chromatograph method.

Flux obtained by adding copper oxide: 5 g to the melt-dehydrated carnallite (simply referred to as “carnallite,” as appropriate): 5 g (compounding ratio: 1) and flux obtained by adding copper oxide: 5 g to a mixed salt consisting of the carnallite: 0.5 g and KCl: 4.5 g (total: 5 g) (compounding ratio: 1) were prepared. The carnallite and the mixed salt were used in a granular form without re-solidification.

### (2) Processing

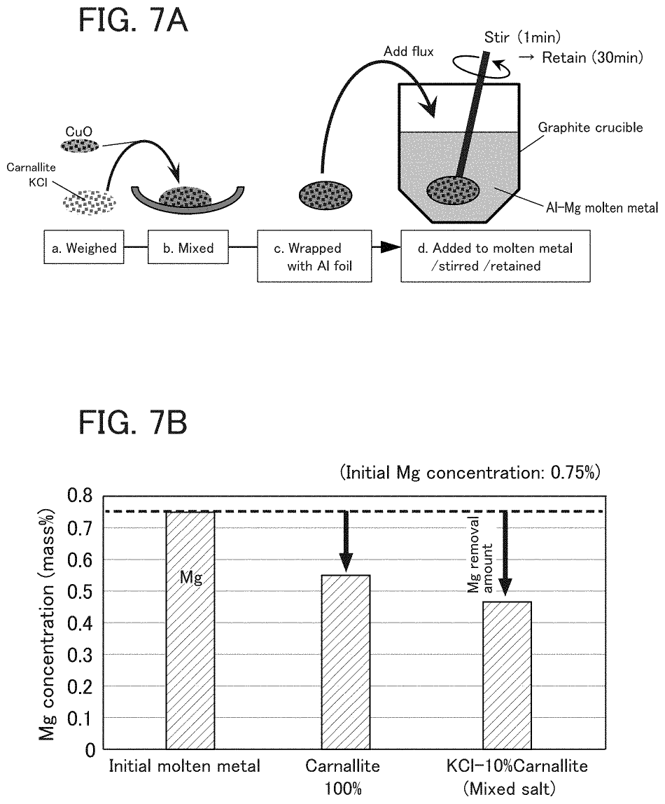

The Mg removal process was performed by adding each flux (10 g) to the molten Al alloy (molten metal 4 of Table 1/1000 g) in accordance with the procedure illustrated in FIG. 7A. The temperature of the molten metal was set to 710° C. and the retention time after the stirring was set to 30 minutes.

### (3) Evaluation

The Mg concentration and Cu concentration in the Al alloy before and after the Mg removal process are illustrated in FIG. 7B in comparison. As is apparent from FIG. 7B, it has been found that the Mg concentration in the molten Al alloy can be similarly lowered even with the flux prepared by using a mineral-derived chloride.

Moreover, the Mg concentration was further lowered by using a mixed salt of KCl and carnallite rather than using only carnallite when compounding the flux. It is considered that when carnallite containing a large amount of MgCl₂ is used, vaporization of MgCl₂ and generation of Cl₂ occur during the Mg removal process, resulting in the reduced amount of chloride itself.

In any case, by using minerals for the chloride containing Mg, the cost of flux can be reduced by omitting the re-solidification of chloride, the working environment can be improved by suppressing the chlorine gas generated during the Mg removal process, and other advantageous effects can be obtained.

From the above, it has been confirmed that Mg can be efficiently removed from a molten Al alloy by using the Mg removal agent of the present invention.

TABLE 1

| Molten | Composition of aluminum alloy molten metal | | | | | |
|---|---|---|---|---|---|---|
| metal | (mass %/the balance: Al) | | | | | |
| No. | Mg | Si | Fe | Cu | Mn | Zn |
| 1 | 0.75 | — | — | — | — | — |
| 2 | 0.53 | 2.01 | 0.14 | 0.03 | — | 0.01 |
| 3 | 0.85 | 1.56 | 0.23 | 0.02 | — | — |
| 4 | 0.75 | 2.67 | 0.16 | 0.02 | — | — |

TABLE 2

Composition of chloride
(mass %)

Base salt

| Chloride | | | KCl |
|---|---|---|---|
| No. | MgCl₂ | NaCl | (The balance) |
| 1 | 0 | 44 | 56 |
| 2 | 0.3 | 43.9 | 55.8 |
| 3 | 1 | 43.6 | 55.4 |
| 4 | 5 | 41.8 | 53.2 |
| 5 | 10 | 39.6 | 50.4 |

TABLE 3

Compounding of flux

| | Compounding ratio | Chloride (mass %) |
|---|---|---|
| Compounding | (Chloride/ | [Chloride/(Chloride + |
| No. | Copper oxide) | Copper oxide)] |
| 1 | 0 | 0 |
| 2 | 0.1 | 9.1 |
| 3 | 0.17 | 14.5 |
| 4 | 0.2 | 16.7 |
| 5 | 1 | 50 |
| 6 | 2 | 67 |
| 7 | 4 | 80 |
| 8 | 9 | 90 |

1. A Mg removal agent used for removing Mg from an aluminum alloy molten metal,
the Mg removal agent comprising a chloride and a copper oxide,
the chloride having at least Mg and one or more base metal elements selected from K, Na, and Ca.

2. The Mg removal agent according to claim 1, wherein the chloride contains 0.2 to 60 mass % of MgCl₂ with respect to the chloride as a whole.

3. The Mg removal agent according to claim 1, wherein the chloride contains 40 to 99.8 mass % of KCl with respect to the chloride as a whole.

4. The Mg removal agent according to claim 1, wherein a compounding ratio that is a mass ratio of the chloride to the copper oxide is 0.15 or more.

5. The Mg removal agent according to claim 1, wherein the chloride is a re-solidified salt or a mixed salt.

6. The Mg removal agent according to claim 1, wherein at least a part of the chloride is a mineral containing the base metal elements and Mg or a mineral-derived chloride obtained from the mineral.

7. The Mg removal agent according to claim 1, wherein the Mg removal agent is granular flux introduced into the aluminum alloy molten metal.

8. A production method for obtaining an aluminum alloy having a reduced Mg concentration, the production method comprising
bringing the Mg removal agent according to claim 1 into contact with an aluminum alloy molten metal containing Mg.
